(19) United States
(12) Patent Application Publication
(10) Pub. No.: US 2024/0346383 A1
(43) Pub. Date: Oct. 17, 2024

(54) MODEL LEARNING DEVICE, METHOD AND PROGRAM

(71) Applicant: Nippon Telegraph and Telephone Corporation, Tokyo (JP)

(72) Inventors: Masahiro KOJIMA, Musashino-shi, Tokyo (JP); Yuta NAMBU, Musashino-shi, Tokyo (JP); Yuki KURAUCHI, Musashino-shi, Tokyo (JP); Ryuji YAMAMOTO, Musashino-shi, Tokyo (JP)

(21) Appl. No.: 18/699,077

(22) PCT Filed: Oct. 26, 2021
(86) PCT No.: PCT/JP2021/039467

§ 371 Date: Apr. 5, 2024

(51) Int. Cl. G06N 20/00

(52) U.S. Cl. CPC G06N 20/00

(57) ABSTRACT

An aspect of the present invention acquires learning data including grouped uncoupled data acquired from a plurality of groups to be investigated, and grouped size comparison data. First, a processing of updating a hyperparameter using a first optimization method is executed on the obtained grouped uncoupled data, and an optimization hyperparameter that minimizes a first objective function is estimated. Next, a processing of updating a parameter using a second optimization method is executed on the basis of the acquired grouped uncoupled data and grouped size comparison data and the estimated optimization hyperparameter, and an optimization parameter that minimizes a second objective function is estimated. Finally, the estimated optimization parameter is outputted.

### TECHNICAL FIELD

One aspect of the present invention relates to a model learning device, a method, and a program for performing model learning using uncoupled data.

### BACKGROUND ART

Learning a model representing an input/output relationship from data is one of typical problems in the field of machine learning and artificial intelligence. In this problem, data provided as a set of input and output value pairs indicating what the output value at the time of a certain input value is, that is, data for which an input/output correspondence has been found is normally used for learning a model.

However, in recent years, due to the influence of, for example, a data collection technique and processing for privacy protection, there is an increasing situation in which it is necessary to estimate a parameter on the basis of so-called uncoupled data for which an input/output correspondence relationship has not been found and learn a model representing the input/output relationship. An example of a conceivable case is that information indicating a basic attribute (gender, age, etc.) or a life pattern (average wake-up time, average exercise time per week, etc.) of the user is inputted, and the annual income of the user is estimated on the basis of the inputted information.

In normal model learning that uses data for which an input/output correspondence has been found, a parameter of a model is estimated using data {xᵢ, yᵢ}ⁿᵢ₌₁ expressed as a set of input and output pairs, where i denotes an index representing a user, xᵢ denotes an input value (attribute/life pattern) of the user i, and yᵢ denotes an output value (annual income) of the user i. Here, n denotes the total number of users.

On the other hand, in model learning that uses uncoupled data, a set of inputs {xm}^{n′X}ₘ₌₁ and a set of outputs {ym′}^{n′Y}_{m′=1} are provided separately as learning data without being associated with each other. Here, n′_{X} and n′_{Y} denote the number of pieces of each data, while n′_{X} and n′_{Y} are generally not equal because, for example, there is a user who does not answer only the output value. For these pieces of data, an input/output correspondence has not been found, and for example, which one of {y₁, y₂, . . . , y_{n′Y}} is the output value of the user who has answered xₘ as the input value is not known. In a case where sensitive data such as “annual income” is collected as in this example, the uncoupled data is created by collecting the output value so as not to be recorded in association with the user from the viewpoint of privacy protection and the like.

As an existing technology of model learning that uses uncoupled data, for example, a technique described in Non Patent Literature 1 and a technique described in Non Patent Literature 2 are known.

### CITATION LIST

### Non Patent Literature

Non Patent Literature 1: A. Carpentier and T. Schlu\ddot{ }ter. “Learning relationships between data obtained independently.” In Artificial Intelligence and Statistics, pp. 658-666, 2016.

Non Patent Literature 2: Liyuan Xu, Gang Niu, Junya Honda, and Masashi Sugiyama. “Uncoupled regression from pairwise comparison data.” In Proceedings of the 33rd International Conference on Neural Information Processing Systems, pp. 3992-4002, 2019.

### SUMMARY OF INVENTION

### Technical Problem

However, the technology described in Non Patent Literature 1 needs to satisfy conditions that are difficult to practically use, and is not suitable for practical use.

On the other hand, the technique described in Non Patent Literature 2 is to perform model learning under a practical condition that size comparison data is used in addition to uncoupled data, and is expected to be used. Here, the size comparison data is data given in a format of {(x⁺ₘ, x⁻ₘ)}^{n′c}ₘ₌₁. The n′_{c} denotes the number of pieces of data. The data indicates that the output value of a user who has answered x′ₘ as the input value is larger than the output value of a user who has answered x⁻ₘ as the input value, and the output value itself has not been observed. Such data can be acquired by asking the user to answer whether an output value (e.g., annual income) is larger than an output value of another user or not. Such data puts a smaller psychological burden on the user than answering the annual income itself such as 3 million yen or 5 million yen, and it is easy to collect the data in many cases.

However, Non Patent Literature 2 does not consider a case where uncoupled data are grouped. That is, generally in a data analysis site, data collection is often carried out a plurality of times (n_{K} times) while changing a period and a user group. In this case, available data is grouped uncoupled data.

Specifically, all users are divided into n_{K} groups (depending on the number of times each user participates in data collection), so that it is possible to know which group the answer of each user belongs to as in the uncoupled data described above, though the input and the output do not correspond to each other. That is, after data collection is carried out n_{K} times, available learning data is given as follows.

Pair of input values: D_{X}={D_{Xk}}^{nK}ₖ₌₁={{xₖₘ}n^{Xk}ₘ₌₁}n^{K}ₖ₌₁

Pair of output values: D_{Y}={D_{Yk}}^{nK}ₖ₌₁={{yₖₘ}n^{Yk}ₘ₌₁}n^{K}ₖ₌₁

Here, xₖₘ denotes an input value of any user belonging to the k-th group, yₖₘ denotes an output value of any user belonging to the k-th group, n_{Xk} denotes the number of pieces of data of the input value of the k-th group, and n_{Yx} denotes the number of pieces of data of the output value of the k-th group. Hereinafter, symbols n_{X} and n_{Y} denote the total number of pieces of data, and n_{X} and n_{Y} are respectively defined as follows.

$${n}_{X} = {\sum }_{k = 1}^{nk} {n}_{Xk}$$

$${n}_{Y} = {\sum }_{k = 1}^{nk} {n}_{Yk}$$

In view of the actual situation in this manner, there is a need for a technology capable of performing model learning even when uncoupled data are grouped.

The present invention has been made in view of the above circumstances, and an object thereof is to provide a technology for enabling highly accurate model learning even in a case of using grouped uncoupled data.

### Solution to Problem

In order to solve the above problem, one aspect of a model learning device or a model learning method according to the present invention acquires learning data including grouped uncoupled data acquired from a plurality of groups to be investigated, and grouped size comparison data. First, a processing of updating a hyperparameter using a first optimization method is executed on the obtained grouped uncoupled data, and an optimization hyperparameter that minimizes a first objective function is estimated. Next, a processing of updating a parameter using a second optimization method is executed on the basis of the acquired grouped uncoupled data and grouped size comparison data and the estimated optimization hyperparameter, and an optimization parameter that minimizes a second objective function is estimated. Finally, the estimated optimization parameter is outputted.

### Advantageous Effects of Invention

According to one aspect of the present invention, it is possible to provide a technology capable of performing highly accurate model learning even for grouped uncoupled data while satisfying practical conditions by using grouped size comparison data in addition to the uncoupled data.

### BRIEF DESCRIPTION OF DRAWINGS

FIG. 1 is a block diagram illustrating an example of a hardware configuration of a model learning device according to an embodiment of the present invention.

FIG. 2 is a block diagram illustrating an example of a software configuration of a model learning device according to an embodiment of the present invention.

FIG. 3 is a flowchart illustrating an example of a processing procedure and processing contents of parameter estimation processing executed by the model learning device illustrated in FIG. 2.

FIG. 4 is a flowchart illustrating an example of a processing procedure and processing contents of hyperparameter estimation processing in the processing procedure illustrated in FIG. 3.

FIG. 5 is a flowchart illustrating an example of a processing procedure and processing contents of parameter estimation processing in the processing procedure illustrated in FIG. 3.

### DESCRIPTION OF EMBODIMENTS

Embodiments according to the present invention will be described below with reference to the drawings.

### Embodiment

An embodiment of the present invention is a technique of performing model learning using grouped uncoupled data and size comparison data, and the technique will be hereinafter referred to as grouped uncoupled regression (GUR).

### Configuration Example

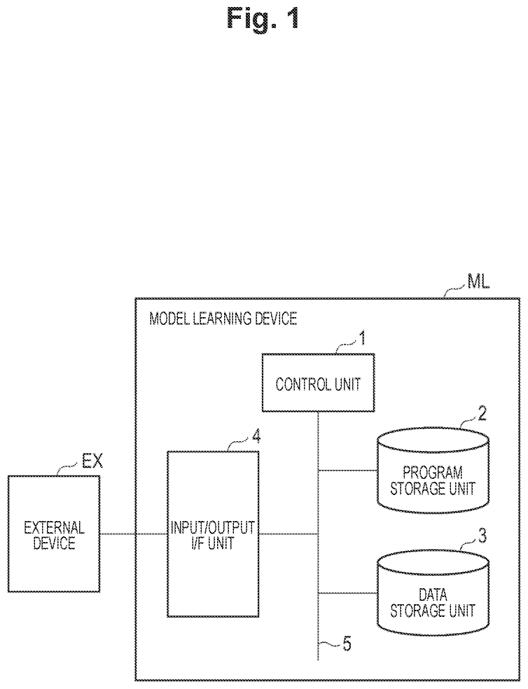

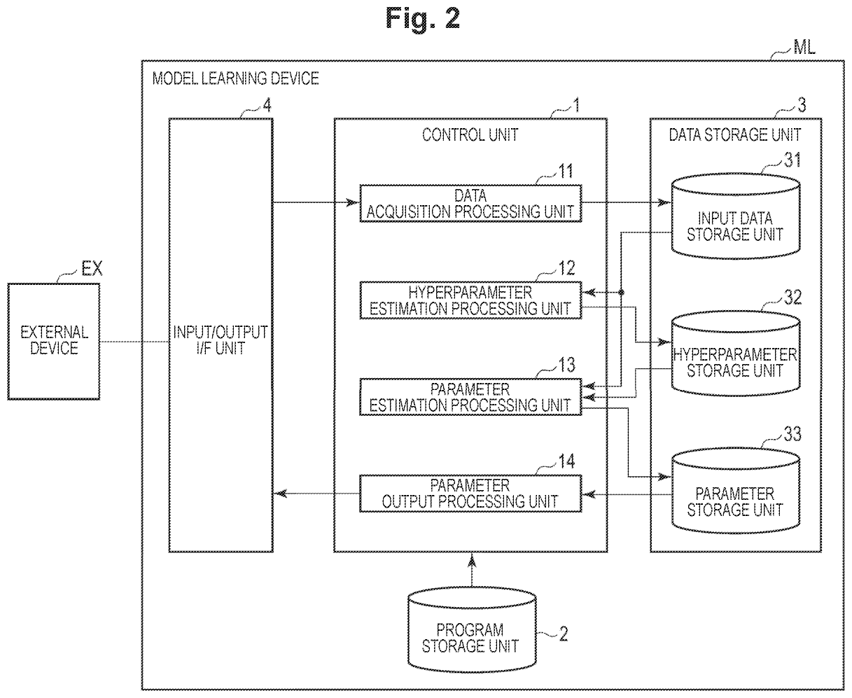

FIGS. 1 and 2 are block diagrams respectively illustrating a hardware configuration example and a software configuration example of a model learning device according to an embodiment of the present invention.

A model learning device ML is configured with, for example, a server computer or a personal computer. The model learning device ML includes a control unit 1 that uses a hardware processor such as a central processing unit (CPU), and a storage unit having a program storage unit 2 and a data storage unit 3, and an input/output interface (which will be hereinafter referred to as I/F) unit 4 are connected with the control unit 1 via a bus 5. Note that the model learning device ML may further include a communication I/F unit and the like.

An external device EX that performs data analysis processing and the like is connected with the input/output I/F unit 4 via a signal cable or a network. The input/output I/F unit 4 is used to receive learning data to be used for model learning from the external device EX and output parameters estimated by the model learning to the external device EX.

The program storage unit 2 is configured by combining, for example, a non-volatile memory capable of writing and reading as needed, such as a hard disk drive (HDD) or a solid state drive (SSD), and a non-volatile memory such as a read only memory (ROM) as storage media, and stores various programs required for executing various kinds of control processing according to an embodiment of the present invention, in addition to middleware such as an operating system (OS).

The data storage unit 3 is configured by combining, for example, a non-volatile memory capable of writing and reading as needed, such as an HDD or an SSD, and a volatile memory such as a random access memory (RAM) as storage media, and includes an input data storage unit 31, a hyperparameter storage unit 32, and a parameter storage unit 33 as storage areas necessary for implementing an embodiment of the present invention.

The input data storage unit 31 is used to store learning data received from the external device EX.

The hyperparameter storage unit 32 is used to temporarily store a hyperparameter estimated by hyperparameter estimation processing by the control unit 1 to be described later, for parameter estimation processing.

The parameter storage unit 33 is used to temporarily store a parameter estimated by parameter estimation processing by the control unit 1 to be described later, until the parameter is outputted to the external device EX.

The control unit 1 includes a data acquisition processing unit 11, a hyperparameter estimation processing unit 12, a parameter estimation processing unit 13, and a parameter output processing unit 14 as processing functions according to an embodiment of the present invention. Each of these processing units 11 to 14 is implemented by causing a hardware processor of the control unit 1 to execute an application program stored in the program storage unit 2. Note that the application program may not be stored in the program storage unit 2 in advance, and may be downloaded from the external device EX or another server device as necessary, for example.

The data acquisition processing unit 11 performs processing of fetching learning data to be used for model learning transmitted from the external device EX via the input/output I/F unit 4 and storing the fetched learning data in the input data storage unit 31. The learning data includes grouped uncoupled data and size comparison data. Among them, the size comparison data is, for example, data acquired by asking a user to be investigated to answer whether an output value is larger or smaller than an output value of another user in a questionnaire.

The hyperparameter estimation processing unit 12 reads grouped uncoupling data from the input data storage unit 31, and performs hyperparameter update processing on the read uncoupling data using, for example, a subgradient method. Then, when the number of times of repetition of the update processing exceeds a predetermined number of times or the variation width between before and after the update becomes smaller than a threshold, the updated hyperparameter is stored in the hyperparameter storage unit 32.

The parameter estimation processing unit 13 reads the inputted uncoupled data and size comparison data from the input data storage unit 31, and reads the updated hyperparameter from the hyperparameter storage unit 32. Then, for example, processing of estimating a parameter that minimizes the objective function is performed using a gradient method, and processing of storing the estimated parameter in the parameter storage unit 33 is performed.

After the end of the model learning processing, the parameter output processing unit 14 reads the estimated parameter from the parameter storage unit 33, and performs processing of sending the read parameter from the input/output I/F unit 4 to the external device EX.

### Operation Example

Next, an operation example of the model learning device ML configured as described above will be described.

### (1) Outline of Operation

### (1-1) Formulation

First, problem establishment of GUR will be described. GUR uses grouped uncoupled data D_{X} and D_{Y} as learning data. In addition, the following grouped size comparison data D_{C} collected for each group is used.

$${D}_{C} = {\{ {D}_{Ck} \}}_{k = 1}^{nK} = {\{ {\{ ( {x}_{k m}^{+} , {x}_{k m}^{-} ) \}}_{m = 1}^{nCk} \}}_{k = 1}^{nK}$$

Here, both x⁺ₖₘ and x⁻ₖₘ denote input values of any user belonging to the k-th group, and indicate that the output value of a user who has answered x⁺ₖₘ is larger than the output value of a user who has answered x⁻ₖₘ. The n_{Ck} denotes the number of pieces of data for size comparison in the k-th group. Moreover, the total number of pieces of size comparison data is denoted by n_{C} and is defined as follows.

n_{C}=P^{nK}ₖ₌₁n_{Ck}

Note that, as will be described later, even if the uncoupled data D_{Y} itself cannot be used, the model can be learned by GUR in a case where there is information regarding the probability distribution of the output value of each group.

### (1-2) Loss Function

Bregman divergence (BD) d_{ϕ} defined by the following expression is used to define the loss function. The d_{ϕ} is expressed as follows.

$${d}_{ϕ} ( x , y ) = ϕ ( x ) - ϕ ( y ) - ( x - y ) ϕ ( y )$$

Note that ϕ denotes a certain convex function, and ψ denotes a first order differential ψ=∇_{ϕ}thereof. By changing the function ϕ, BD can express various functions. For example, a case of ϕ(x)=x² corresponds to the squared error, a case of ϕ(x)=x log (x)+(1−x) log (1−x) corresponds to the logistic loss, ϕ(x)=x log (x) corresponds to I-divergence (which will be also referred to as generalized KL divergence), and furthermore, ϕ(x)=−log (x) corresponds to the Itakura-Saito divergence.

Setting a loss function to be used is equivalent to making an assumption on the probability distribution for generating data. Specifically, using the squared error, I-divergence, and Itakura-Saito divergence respectively corresponds to an assumption that data is generated according to normal distribution, Poisson distribution, and exponential distribution.

In defining the loss function, symbols are defined. The random variable whose realization corresponds to the group index is written as K, the random variable corresponding to the input value is written as X, and the random variable corresponding to the output value is written as Y. All the values that can be taken by the input value and the output value are written respectively as Xall and Yall. The probability distribution followed by these random variables is written as P_{K, X, Y}. A distribution obtained by marginalizing the probability distribution P_{K, X, Y} with respect to K is written as P_{X, Y,} and the conditional probability distribution and the probability density function conditioned with K=k are written respectively as P_{X, Y|k} and f_{X, Y|k}. The distribution obtained by further marginalizing this conditional distribution with respect to X or Y is written as P_{Y|k} or P_{Y|k}. The probability density function of the probability distribution P_{Y|k} is written as f_{Y|k}, and the cumulative density function is written as F_{Y|k}. According to the above definition, the cumulative density function F_{Y|k} is expressed as follows.

$${F}_{Y \vert k} ( y ) = {\int }^{{y}_{- ∞}} {f}_{Y \vert k} ( {y}^{′} ) {dy}^{′}$$

The learning model belonging to the hypothesis space H is written as h: Xall→Yall. In the model learning according to the present invention, the learning model to be used is not limited. For example, the present invention can be applied to an arbitrary model such as a linear model (corresponding to considering H={h(x)=θ^{T}x|θ∈R^{d}} as a hypothesis space) or a nonlinear model including deep learning and a kernel method. A loss function used for learning of a model using the above random variable is defined as the following expression as an expected value of Bregman divergence.

$$\begin{matrix}[ Math . 1 ] & \\ ( h ) = {𝔼}_{K , X , Y} [ {d}_{φ} ( Y , h ( X ) ) ] = {𝔼}_{K} [ {ℛ}_{k} ( h ) ] = {\sum }_{k = 1}^{{n}_{K}} P ( K = k ) {ℛ}_{k} ( h ) & ( 1 )\end{matrix}$$

Here, E_{K, X, Y}[·] denotes an expected value according to the probability distribution P_{X, Y}. Moreover, Rₖ is defined as follows.

$$\begin{matrix}[ Math . 2 ] & \\ \begin{matrix}{k}_{} ( h ) = {𝔼}_{X , Y} [ {d}_{φ} ( Y , h ( X ) ) ] \\ = \begin{matrix}{𝔼}_{Y \vert k} [ φ ( Y ) ] - {𝔼}_{X \vert k} [ φ ( h ( X ) ) - \\ h ( X ) ψ ( h ( X ) ) - {𝔼}_{X , Y \vert k} [ Y ψ ( h ( X ) ) ]\end{matrix}\end{matrix} & ( 2 )\end{matrix}$$

In Expression 2, E_{Y|k}, E_{X|k}, and E_{X, Y|k} respectively denote expected values of the probability distributions P_{Y|k}, P_{X|k}, and P_{X, Y|k}. A difficulty in evaluating this loss function lies in E_{X, Y|k}[Yψ(h(X))], which is the final term of Rₖ. This is because, although this term is defined by the simultaneous distribution of the random variables X and Y that denote the input value and the output value, the input value and the output value in the problem establishment of the present invention are set to use uncoupled data that is not observed at the same time, and thus, even if sample approximation is performed, calculation cannot be performed. Therefore, it is considered in the following to approximately evaluate this term.

That is, a pair of random variables (X⁺, X⁻) in which the realization corresponds to the input value is newly introduced. This indicates that the output value of the input X⁺ is larger than the output value of the input X⁻ in a state where a certain group k is fixed, and is defined as follows.

$$\begin{matrix}[ Math . 3 ] & \\ {X}^{+} = \{ \begin{matrix}X ( Y \geq {Y}^{′} ) \\ {X}^{′} ( Y < {Y}^{′} )\end{matrix} , {X}^{-} = \{ \begin{matrix}{X}^{′} ( Y \geq {Y}^{′} ) \\ X ( Y < {Y}^{′} )\end{matrix} & \end{matrix}$$

Here, both (X, Y) and (X′, Y′) are independent random variables according to the probability distribution P_{X, Y|k}. From this definition, it is used later that the above-described size comparison data D_{Ck} can be regarded as a realization of the random variable. Hereinafter, probability density functions according to X⁺ and X⁻ in a state where certain k is fixed are respectively written as f_{Y+|k} and f_{X-|k}, and expected value operations regarding output of X⁺ and X⁻ are written as E_{X+|k}[·] and E_{X-|k}[·]. By using this random variable, it can be shown that the following expression is satisfied.

$$\begin{matrix}[ Math . 4 ] & \\ {𝔼}_{{X}^{+} \vert k} [ ψ ( h ( {X}^{+} ) ) ] = 2 {𝔼}_{X , Y \vert k} [ {F}_{Y \vert k} ( Y ) ψ ( h ( X ) ) ] & ( 3 )\end{matrix}$$

$${𝔼}_{{X}^{-} \vert k} [ ψ ( h ( {X}^{-} ) ) ] = 2 {𝔼}_{X , Y \vert k} [ \{ 1 - {F}_{Y \vert k} ( Y ) \} ψ ( h ( X ) ) ] \qquad ( 4 )$$

Hereinafter, the above Expressions (3) and (4) will be proved.

That is, from the definition of X⁺, f_{X+|k} can be deployed as follows.

$$\begin{matrix}[ Math . 5 ] & \\ \begin{matrix}{f}_{{X}^{+} \vert k} ( x ) = \frac{1}{Z} \int \int \int {f}_{X , Y \vert k} ( x , y ) {f}_{X , Y \vert I = i} ( {x}^{′} , {y}^{′} ) 𝕀 ( y > {y}^{′} ) {dydy}^{′} {dx}^{′} \\ = \frac{1}{Z} \int \int {f}_{X , Y \vert k} ( x , y ) [ \int {f}_{Y \vert k} ( {y}^{′} ) 𝕀 ( y > {y}^{′} ) {dy}^{′} ] dy \\ = \frac{1}{Z} \int {f}_{X , Y \vert k} ( x , y ) {F}_{Y \vert k} ( y ) dy\end{matrix} . & \end{matrix}$$

Here, Z is a normalization constant and is derived from partial integration as Z=½. By using this, Expression (3) can be derived as follows.

$$\begin{matrix}[ Math . 6 ] & \\ \begin{matrix}{𝔼}_{{X}^{+} \vert k} [ ψ ( h ( {X}^{+} ) ) ] = \int {f}_{{X}^{+} \vert k} ( x ) ψ ( h ( x ) ) dx \\ \int 2 \{ {f}_{X , Y \vert k} ( x , y ) {F}_{Y \vert k} ( y ) dy \} ψ ( h ( x ) ) dx \\ 2 {𝔼}_{X , Y \vert k} [ {F}_{Y \vert k} ( Y ) ψ ( h ( X ) ) ]\end{matrix} & \end{matrix}$$

Note that Expression (4) can be similarly derived.

By using Expressions (3) and (4), the final term of Expression (2) can be deformed into the following expression when the probability density function f_{Yk} is a uniform distribution on [0, 1], that is, F_{Y|k}(y)=y is satisfied.

$${E}_{X , Y \vert k} [ Y ψ ( h ( X ) ) ] = {E}_{{X}^{+} \vert k} [ ψ ( h ( {X}^{+} ) ) ) ] / 2$$

In view of this fact, it is considered to be promising to use the approximate form shown in the following expression using certain hyperparameters Wₖ₁, Wₖ₂ ∈R.

$$\begin{matrix}[ Math . 7 ] & \\ {𝔼}_{X , Y \vert k} [ Y ψ ( h ( X ) ) ] \approx {w}_{k 1} {𝔼}_{{X}^{+} \vert k} [ ψ ( h ( {X}^{+} ) ) ] + {w}_{k 2} {𝔼}_{{X}^{-} \vert k} [ ψ ( h ( {X}^{-} ) ) ] & ( 5 )\end{matrix}$$

Here, the symbol (symbol with two-arranged vertically) indicates that the value on the right side approximates the value on the left side.

As described above, in a case where f_{Y|k} is a uniform distribution on [0, 1], this approximation is accurate if (wₖ₁, wₖ₂)=(½, 0) is satisfied. This can be also generalized to the following case of a uniform distribution on [a, b].

$${F}_{Y \vert k} ( y ) = ( y - a ) / ( b - a ) for all y ∈ [ a , b ]$$

It may be assumed that (wₖ₁, wₖ₂)=(b/2, a/2) is satisfied. In the case of considering a more general distribution rather than a uniform distribution, hyperparameters (wₖ₁, wₖ₂) can be determined so as to minimize the upper bound of the generalization loss R. This will be described later.

By calculating the sum of Expressions (3) and (4), the following expression is derived.

$${𝔼}_{X , Y \vert k} [ ψ ( h ( X ) ) ] = \frac{1}{2} {𝔼}_{{X}^{+} \vert k} [ ψ ( h ( {X}^{+} ) ) ] + \frac{1}{2} {𝔼}_{{X}^{-} \vert k} [ ψ ( h ( {X}^{-} ) ) ] \qquad [ Math . 8 ]$$

By using this, Expression (5) can be deformed into the following expression using a constant λₖ.

$$\begin{matrix}[ Math . 9 ] & \\ {𝔼}_{X , Y \vert k} [ Y ψ ( h ( X ) ) ] ] \approx {λ}_{k} {𝔼}_{X , Y \vert k} [ ψ ( h ( X ) ) ] + ( {w}_{k 1} - \frac{{λ}_{k}}{2} ) {𝔼}_{{X}^{+} \vert k} [ ψ ( h ( {X}^{+} ) ) ] + ( {w}_{k 2} - \frac{{λ}_{k}}{2} ) {𝔼}_{{X}^{-} \vert k} [ ψ ( h ( {X}^{-} ) ) ] & ( 6 )\end{matrix}$$

There is a degree of freedom in setting λₖ, and for example, λₓ=0 or λₖ=(wₖ₁+wₖ₂)/2 can be arbitrarily set. By using Expression (6), the approximation R^{˜} of the generalization loss R of Expression (1) is obtained as follows.

$$( h ) = {𝔼}_{K} [ {k}_{} ( h ) ] \qquad [ Math . 10 ]$$

$$where$$

$${k}_{} ( h ) = {k}_{} - {𝔼}_{X \vert k} [ φ ( h ( X ) ) - ( h ( X ) - {λ}_{k} ) ψ ( h ( X ) ) ] - ( {w}_{k 1} - \frac{{λ}_{k}}{2} ) {𝔼}_{{X}^{+} \vert k} [ ψ ( h ( {X}^{+} ) ) ] - ( {w}_{k 2} - \frac{{λ}_{k}}{2} ) {𝔼}_{{X}^{-} \vert k} [ ψ ( h ( {X}^{-} ) ) ]$$

Here, Cᵢ is a constant independent of the model h.

Therefore, by replacing the expected values regarding the random variables K, X, X⁺, and X⁻ with a sample average, the experience loss R\hat{ } is obtained as follows.

$$( h ) = - \frac{1}{{n}_{X}} {\sum }_{{x}_{km} ∈ {X}_{}} \{ φ ( h ( {x}_{km} ) ) - ( h ( {x}_{km} ) - {λ}_{k} ) ψ ( h ( {x}_{km} ) ) \} - \frac{1}{{n}_{C}} {\sum }_{( {x}_{km}^{+} , {x}_{km}^{-} ) ∈ {C}_{}} \{ ( {w}_{k 1} - \frac{{λ}_{k}}{2} ) ψ ( h ( {x}_{km}^{+} ) ) + ( {w}_{k 2} - \frac{{λ}_{k}}{2} ) ψ ( h ( {x}_{km}^{-} ) ) \} \qquad [ Math . 11 ]$$

Here, C is a constant independent of the model h. Since this amount is an amount that can be calculated from the data except for the constant C, the amount can be used as an objective function for estimating the parameter. Therefore, the model can be learned by optimizing the following objective function L obtained by removing the constant C from the experience loss R\hat{ }.

$$\begin{matrix}[ Math . 12 ] & \\ ℒ ( h ) = - \frac{1}{{n}_{X}} {\sum }_{{x}_{km} ∈ {X}_{}} \{ φ ( h ( {x}_{km} ) ) - ( h ( {x}_{km} ) - {λ}_{k} ) ψ ( h ( {x}_{km} ) ) \} - \frac{1}{{n}_{C}} {\sum }_{( {x}_{km}^{+} , {x}_{km}^{-} ) ∈ {C}_{}} \{ ( {w}_{k 1} - \frac{{λ}_{k}}{2} ) ψ ( h ( {x}_{km}^{+} ) ) + ( {w}_{k 2} - \frac{{λ}_{k}}{2} ) ψ ( h ( {x}_{km}^{-} ) ) \} & ( 7 )\end{matrix}$$

For the optimization, an arbitrary method such as a gradient method, a (pseudo) Newton method, a stochastic gradient method, or Adam can be used. For example, in a case where the optimization processing by a gradient method is performed on learning of a model having the parameter θ, the processing of updating the parameter may be repeated according to the following expression.

$$\begin{matrix}[ Math . 13 ] & \\ θ ← θ - γ \frac{\partial }{\partial θ} ℒ ( h ) & ( 8 )\end{matrix}$$

Here, γ denotes a learning rate. Note that a function obtained by adding an arbitrary regularization term regarding the parameter of the model, for example, an L₁ norm, an L₂ norm, or the like to the above objective function may be employed as the objective function.

Moreover, the following objective function L\hat{ } obtained by approximating the objective function L can also be used for learning the model.

$$\hat{ℒ} ( h ) = - \frac{1}{{n}_{X}} {\sum }_{{x}_{km} ∈ {X}_{}} [ φ ( h ( {x}_{km} ) ) - ( h ( {x}_{km} ) - {\overline{y}}_{km} ) ψ ( h ( {x}_{km} ) ) ] \qquad [ Math . 14 ]$$

$${\overline{y}}_{km} = {λ}_{k} + {n}_{X} {γ}_{km}^{+} ( {w}_{k 1} - \frac{{λ}_{k}}{2} ) + {n}_{X} {γ}_{km}^{-} ( {w}_{k 2} - \frac{{λ}_{k}}{2} )$$

$${γ}_{km}^{+} = \frac{1}{{n}_{C}} {\sum }_{( {x}_{k ℓ}^{+} , {x}_{k ℓ}^{-} ) ∈ {C}_{}} Ind ( {x}_{km} = {Nearest}_{{{X}_{k}}_{}} ( {x}_{k ℓ}^{+} ) )$$

$${γ}_{km}^{-} = \frac{1}{{n}_{C}} {\sum }_{( {x}_{k ℓ}^{+} , {x}_{k ℓ}^{-} ) ∈ {C}_{}} Ind ( {x}_{km} = {Nearest}_{{{X}_{k}}_{}} ( {x}_{k ℓ}^{-} ) )$$

Note that, the symbol Nearest_{Dxk} (z) in the above expression represents a function that returns data xₖₘ ∈D_{Xk} closest to z, and the symbol Ind (·) denotes an indication function that returns 1 when · is true, otherwise 0.

The objective function L\hat{ } is equivalent to an objective function used when model learning is performed using data {xₖₘ, y^{˜}ₖₘ}n^{Xk}ₘ₌₁}n^{K}ₖ₌₁ in which the output value y^{˜}ₖₘ is regarded as a pseudo value corresponding to the input value xₖₘ and a correspondence between the input value and the output value has been found. Here, a constant term is excluded. Accordingly, the model learning technique in the case of using the data in which the correspondence between the input value and the output value has been found can be applied as it is to the optimization of the objective function L\hat{ }.

That is, when the optimization parameter is estimated, processing of updating the parameter using the objective function L\hat{ } obtained by regarding the value calculated on the basis of the hyperparameters wₖ₁ and wₖ₂ regarded as pseudo output values corresponding to the input value to approximate the objective function L may be executed, thereby estimating the optimization parameter θ that minimizes the objective function L\hat{ }.

### (1-3) Hyperparameter Estimation

Finally, a hyperparameter {wₖ₁, wₖ₂} estimation technique will be described.

This hyperparameter can be determined by minimizing the following function Eᵣᵣₖ\hat{ }.

$$\begin{matrix}[ Math . 15 ] & \\ ( {w}_{k 1} , {w}_{k 2} ) = {\sum }_{{y}_{km} ∈ {{Y}_{k}}_{}} \vert {y}_{km} - 2 {w}_{k 1} {\hat{F}}_{Y \vert k} ( {y}_{km} ) - 2 {w}_{k 2} \{ 1 - {\hat{F}}_{Y \vert k} ( {y}_{km} ) \} \vert & ( 9 )\end{matrix}$$

Here, F_{Y|k}\hat{ } is the following empirical approximation of the cumulative density function F_{Y|k}.

$${\hat{F}}_{Y \vert k} = \frac{1}{{n}_{{Y}_{k}}} {\sum }_{{y}_{km} ∈ {{Y}_{k}}_{}} ( {y}_{km} \leq y ) \qquad [ Math . 16 ]$$

This corresponds to sample approximation of the following upper bound of the error of approximation by Rₖ^{˜} of the function Rₖ by using a part D_{Y} of uncoupled data.

$${Err}_{k} ( {w}_{k 1} , {w}_{k 2} ) = \int {f}_{Y \vert k} ( y ) \vert y - 2 {w}_{k 1} {F}_{Y \vert k} ( y ) - 2 {w}_{k 2} \{ 1 - {F}_{Y \vert k} ( y ) \} \vert dy \qquad [ Math . 17 ]$$

Although the probability density function f_{Y|k} in the function Eᵣᵣₖ and the cumulative density function F_{Y|k} thereof are generally unknown and therefore the function Eᵣᵣₖ cannot be calculated, the function Eᵣᵣₖ\hat{ } can be calculated using the data D_{Yk}, and optimization can be performed.

An arbitrary optimization technique can be used for the optimization processing. For example, since Expression (9) is defined by the sum of absolute values, it is desirable to use a technique that can be handled even if there is an undifferentiable point in the objective function such as a subgradient method, a linear programming method, or the like. When a subgradient method is used, the updating of the parameter may be repeated according to the following expression, using an arbitrary vector g belonging to the set of subgradients ∂Eᵣᵣₖ\hat{ } (wₖ₁, wₖ₂) in wₖ=(Wₖ₁, wₖ₂) of the function Eᵣᵣₖ\hat{ }.

$$\begin{matrix}[ Math . 18 ] & \\ {w}_{k} ← {w}_{k} - {γ}^{′} g ( s . t . g ∈ \partial ( {w}_{k 1} , {w}_{k 2} ) ) & ( 10 )\end{matrix}$$

Here, γ′ denotes a learning rate.

Moreover, as is clear from the above discussion, even if the data D_{Y} itself cannot be used, the hyperparameter can be estimated by directly minimizing Eᵣᵣₖ as long as prior knowledge or the like regarding the probability density function {f_{Y|k}}^{nK}ₖ₌₁ regarding the output of each group can be used. Since Eᵣᵣₖ includes an integral, all the values that can be taken by y, for example, are discretely divided into {y_{L}}^{nsplit}_{L=1} and approximated. For example, the 0.01 quantile of y is defined as y, and the 0.99 quantile is defined as y, and y_{L}=y+(L−1)/nsplit (y⁻-y) is set. Then, considering minimization of the following Expression (11), estimation can be performed by an arbitrary optimization technique as in Eᵣᵣₖ\hat{ }.

$${k}_{} ( {w}_{k 1} , {w}_{k 2} ) = {\sum }_{ℓ = 1}^{{n}_{split}} {f}_{Y \vert k} ( {y}_{ℓ} ) \vert y - 2 {w}_{k 1} {F}_{Y \vert k} ( y ) - 2 {w}_{k 2} \{ 1 - {F}_{Y \vert k} ( y ) \} \vert \qquad [ Math . 19 ]$$

### (2) Operation of Model Learning Device ML

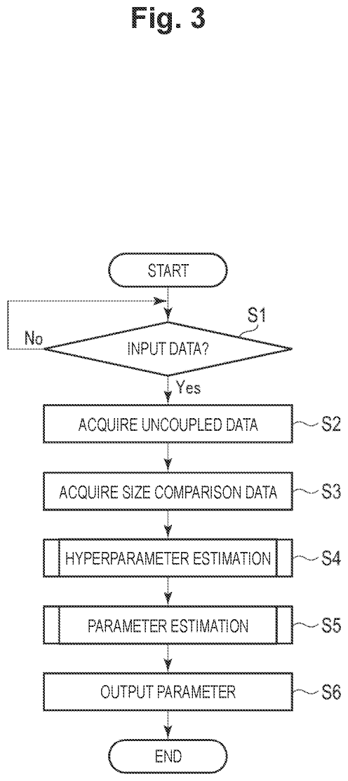

FIG. 3 is a flowchart illustrating a processing procedure and processing contents of model learning processing executed by the control unit 1 of the model learning device ML.

### (2-1) Acquisition of Learning Data

In step S1, the control unit 1 of the model learning device ML monitors input of learning data from the external device EX. When learning data is transmitted from the external device EX in this state, the control unit 1 of the model learning device ML receives the learning data transmitted from the external device EX via the input/output I/F unit 4 in step S2 under the control of the data acquisition processing unit 11, and stores the received learning data in the input data storage unit 31.

The inputted learning data includes the grouped uncoupled data D_{X} and D_{Y}, and the grouped size comparison data D_{C}. Among them, the size comparison data D_{C} is data acquired by asking a user to be investigated to answer whether the output value is larger or smaller than the output value of another user, and expressed as the following expression as described in the formulation of (1−1) above.

$${D}_{C} = {{\{ {D}_{Ck} \}}^{nK}}_{k = 1} = {{\{ {{\{ ( {{x}^{+}}_{km} , {{x}^{-}}_{km} ) \}}^{nCk}}_{m = 1} \}}^{nK}}_{k = 1}$$

Here, both x⁺ₖₘ and x⁻ₖₘ denote input values of any user belonging to the k-th group, and indicate that the output value of a user who has answered x⁺ₖₘ is larger than the output value of a user who has answered x⁻ₖₘ. The n_{Ck} denotes the number of pieces of data for size comparison in the k-th group.

### (2-2) Hyperparameter Estimation

When the learning data is acquired, the control unit 1 of the model learning device ML first reads the uncoupled data D_{Y} from the input data storage unit 31 in step S3 under the control of the hyperparameter estimation processing unit 12. Then, the update processing that uses a subgradient method described below is executed for each group k=1, . . . , nk with respect to the read uncoupled data D_{Y}, and the hyperparameter w is obtained by minimizing the objective function previously shown in Expression (9).

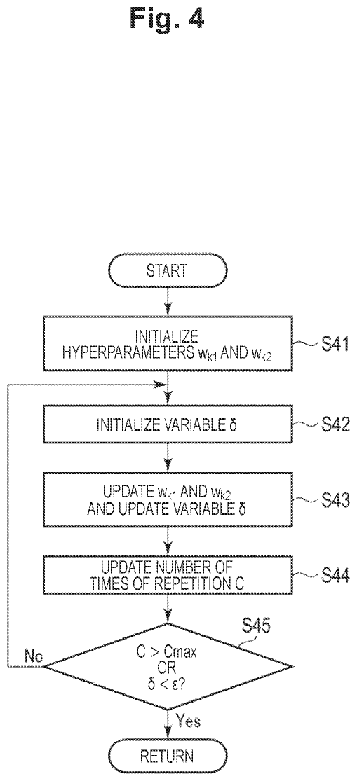

FIG. 4 is a flowchart illustrating an example of a processing procedure and processing contents of hyperparameter update processing that uses a subgradient method.

That is, the hyperparameter estimation processing unit 12 first initializes the hyperparameters wₖ₁ and wₖ₂ in step S41. When the initialization processing ends, the hyperparameter estimation processing unit 12 then initializes the variable δ in step S42. The variable δ is a variable used as a termination condition, and indicates a maximum variation width of the update amount. At the same time, in step S42, the hyperparameter estimation processing unit 12 sets the threshold ϵ and the maximum number of times of repetition C as the termination condition. These values indicating the termination condition are stored in advance in the variable storage area of the data storage unit 3.

Next, in step S43, the hyperparameter estimation processing unit 12 updates the hyperparameter w according to Expression (10) described above. Moreover, every time update processing of the hyperparameters wₖ₁ and wₖ₂ is performed once, the maximum value

$$max ( \vert {{w}^{old}}_{k 1} - {{w}^{new}}_{k 1} \vert , \vert {{w}^{old}}_{k 2} - {{w}^{new}}_{k 2} \vert )$$

of the absolute value of the difference between the hyperparameters wₖ before and after the update is set to a variable δ. Here, note that the elements of the hyperparameter wₖ before update are described respectively as w^{old}ₖ₁ and w^{old}ₖ₂, and the elements after update are described respectively as w^{new}ₖ₁ and w^{new}ₖ₂.

Subsequently, in step S44, the hyperparameter estimation processing unit 12 updates the number of times of update repetition C.

The hyperparameter estimation processing unit 12 determines whether the termination condition is satisfied or not in step S45 every time the update processing of the hyperparameters wₖ₁ and wₖ₂ is performed once. In this example, whether the number of times of update repetition C has exceeded a preset maximum value Cmax or not, or whether the variable δ has become smaller than the threshold ϵ or not is determined. In a case where the number of times of repetition C has not exceeded the maximum value Cmax and the variable δ has not become smaller than the threshold ϵ as a result of the determination, the hyperparameter estimation processing unit 12 returns to step S42 to initialize the variable δ to 0, and then executes the update processing in steps S43 to S45 again. This update processing is repeatedly executed until the termination condition is satisfied.

On the other hand, it is assumed that the number of times of update repetition C exceeds the maximum value Cmax or the variable δ becomes smaller than the threshold ϵ. Then, the hyperparameter estimation processing unit 12 terminates the update processing and stores the finally obtained hyperparameters wₖ₁ and wₖ₂ in the hyperparameter storage unit 32.

### (2-3) Parameter Estimation

When the hyperparameter estimation processing ends, the control unit 1 of the model learning device ML first reads the uncoupled data D_{X} and the size comparison data D_{C} from the input data storage unit 31 in step S5 under the control of the parameter estimation processing unit 13. At the same time, the estimated hyperparameters wₖ₁ and wₖ₂ are read from the hyperparameter storage unit 32. Then, the parameter estimation processing unit 13 executes update processing that uses a gradient method described below to minimize the objective function of Expression (7) described above, thereby obtaining an optimum parameter θ.

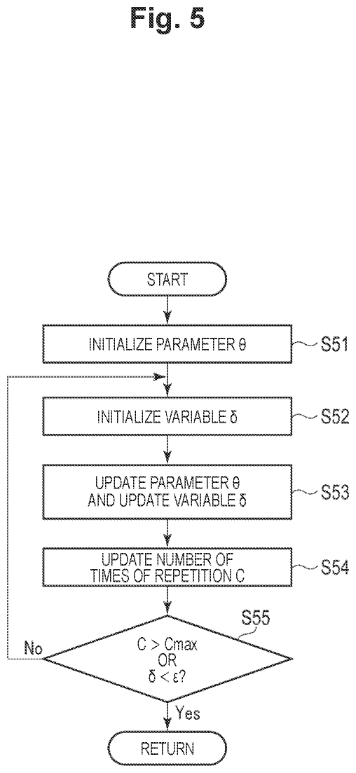

FIG. 5 is a flowchart illustrating an example of a processing procedure and processing contents of parameter update processing that uses a gradient method.

That is, the parameter estimation processing unit 13 first initializes the parameter δ in step S51. Subsequently, in step S52, a variable δ indicating the maximum variation width of the update amount, which is one of the variables used as the termination condition, is similarly initialized, and a threshold ϵ denoting the termination condition and the maximum number of times of repetition C are further set. These values indicating the termination condition are stored in advance in the variable storage area of the data storage unit 3.

Next, in step S53, the parameter estimation processing unit 13 updates the parameter θ according to Expression (8) described above. Moreover, every time the parameter θ is updated once, the maximum value

$${max}_{d} \vert {{θ}^{old}}_{d} - {{θ}^{new}}_{d} \vert$$

of the absolute value of the difference between the parameter θ∈R_{d} before and after the update is set to a variable δ. Here, note that the element of the parameter θ before update is described as θ^{old}_{d}, and the element after update is described as θ^{new}_{d}.

Subsequently, in step S54, the parameter estimation processing unit 13 updates the number of times of update repetition C.

The parameter estimation processing unit 13 determines whether the termination condition of the update processing is satisfied or not in step S55 every time the update processing of the parameter θ is performed once. In this example, whether the number of times of update repetition C has exceeded a preset maximum value Cmax or not, or whether the variable δ has become smaller than the threshold ϵ or not is determined. In a case where the number of times of repetition C has not exceeded the maximum value Cmax and the variable δ has not become smaller than the threshold ϵ as a result of the determination, the parameter estimation processing unit 13 returns to step S52 to initialize the variable δ to 0, and then executes the update processing in steps S53 to S55 again. This update processing is repeatedly executed until the termination condition is satisfied.

On the other hand, it is assumed that the number of times of update repetition C exceeds the maximum value Cmax or the variable δ becomes smaller than the threshold ϵ. Then, the parameter estimation processing unit 13 terminates the update processing of the parameter θ and stores the finally obtained parameter θ in the parameter storage unit 33.

### (2-4) Output of Parameter θ

When the series of model learning processing end, the control unit 1 of the model learning device ML reads the estimated parameter θ from the parameter storage unit 33 and sends the read parameter 0 from the input/output I/F unit 4 to the external device EX in step S6 under the control of the parameter output processing unit 14.

The external device EX creates a learning model using the parameter θ received from the model learning device ML, and thereafter, executes, for example, data analysis processing regarding consumers using this learning model.

### Actions and Effects

As described above, in the model learning device ML according to an embodiment, the grouped uncoupled data D_{X} and D_{Y} and the grouped size comparison data D_{C} are acquired as learning data used for model learning. Then, first, the processing of updating the hyperparameter w using a subgradient method, which is one of the optimization methods, is repeatedly executed for each group with respect to the acquired uncoupled data D_{Y}, and optimization hyperparameters wₖ₁ and wₖ₂ that minimize the objective function are obtained. Next, processing of updating the parameter θ using a gradient method which is one of optimization methods is repeatedly executed on the basis of the acquired uncoupled data D_{X} and size comparison data D_{C} to obtain the optimization parameter θ that minimizes the objective function and the optimization hyperparameters wₖ₁ and wₖ₂, and the obtained optimization parameter θ is outputted.

Accordingly, it is possible to perform highly accurate model learning even for grouped uncoupled data while satisfying practical conditions by using grouped size comparison data in addition to the uncoupled data.

### Other Embodiments

(1) In the above embodiment, a case where a subgradient method is used for the estimation processing of the hyperparameter w and a gradient method is used for the estimation processing of the parameter θ has been described as an example. However, the present invention is not limited thereto, and for example, a linear programming method may be used for the estimation processing of the hyperparameter w, and a (pseudo) Newton method, a stochastic gradient method, an Adam method, or the like may be used for the estimation processing of the parameter θ. In short, an arbitrary technique can be used for the estimation processing of the hyperparameter w and the optimization processing of the parameter θ.

(2) Although the uncoupled data D_{Y} is used for the hyperparameter estimation processing in the above embodiment, information of the probability density function {f_{Y|k}}^{nK}ₖ₌₁ related to the output of each group k may be used instead. This can be realized by, for example, determining whether the data D_{Y} corresponding to the output value is included in the acquired grouped uncoupled data or not, and in a case where the data D_{Y} is not included, obtaining information of a probability density function {f_{Y|k}}^{nK}ₖ₌₁ regarding the output value of each group k and minimizing the objective function by Expression (11) using the probability density function instead of the output value data D_{Y}. In short, an arbitrary technique can be used for optimization of the hyperparameter.

(3) In the above embodiment, a case where the model learning device ML is provided as a device different from the external device EX has been described as an example. However, the present invention is not limited thereto, and the function of the model learning device ML may be provided in the external device EX, and the external device EX may be configured to execute the model learning processing.

In addition, the functional configuration of the model learning device and the processing procedure and processing contents of the model learning processing can be variously modified and implemented without departing from the gist of the present invention.

Although embodiments of the present invention have been described in detail above, the above description is merely exemplification of the present invention in all respects. It is needless to say that various improvements and modifications can be made without departing from the scope of the present invention. That is, a specific configuration according to an embodiment may be appropriately adopted to implement the present invention.

In short, the present invention is not limited to the above embodiments without any change, but can be embodied by modifying the constituent elements without departing from the gist of the invention at the implementation stage. Moreover, various inventions can be formulated by appropriately combining a plurality of constituent elements disclosed in the above embodiments. For example, some constituent elements may be omitted from the entire constituent elements described in the embodiments. Furthermore, constituent elements in different embodiments may be appropriately combined.

### REFERENCE SIGNS LIST

ML Model learning device

EX External device

1 Control unit

2 Program storage unit

3 Data storage unit

4 Input/output I/F unit

5 Bus

11 Data acquisition processing unit

12 Hyperparameter estimation processing unit

13 Parameter estimation processing unit

14 Parameter output processing unit

31 Input data storage unit

32 Hyperparameter storage unit

33 Parameter storage unit

1. A model learning device comprising one or more processors configured to perform operations comprising:
acquiring learning data including grouped uncoupled data acquired from a plurality of groups to be investigated and grouped size comparison data;
executing processing of updating a hyperparameter using a first optimization method on the acquired grouped uncoupled data and estimates an optimization hyperparameter that minimizes a first objective function;
executing processing of updating a parameter using a second optimization method on the basis of the acquired grouped uncoupled data, the grouped size comparison data, and the estimated optimization hyperparameter, and estimates an optimization parameter that minimizes a second objective function; and
outputting the estimated optimization parameter.

2. The model learning device according to claim 1, wherein the operations comprise:
determining whether a variation of the hyperparameter between before and after update is smaller than a preset first threshold or not, or whether a number of times of executions of update processing exceeds a preset first number of times or not every time the update processing of the hyperparameter is performed, and
in a case where the variation is smaller than the first threshold or the number of times of executions of update processing exceeds the first number of times, terminating the update processing and sets the hyperparameter obtained at that time as the optimization hyperparameter.

3. The model learning device according to claim 1, wherein the operations comprise:
determining whether a variation of the parameter between before and after update is smaller than a preset second threshold or not, or whether a number of times of executions of update processing exceeds a preset second number of times or not every time the update processing of the parameter is performed, and
in a case where the variation is smaller than the second threshold or the number of times of executions of update processing exceeds the second number of times, terminating the update processing and sets the parameter obtained at that time as the optimization parameter.

4. The model learning device according to claim 1, wherein the operations comprise:
determining whether output value data is included in the acquired grouped uncoupled data or not;
obtaining information regarding a probability distribution of the output value data of the plurality of groups in a case where the output value data is not included; and
estimating the optimization hyperparameter using the information regarding the probability distribution instead of the output value data.

5. The model learning device according to claim 1, wherein the operations comprise:
using a subgradient method or a linear programming method as the first optimization method, and
using a gradient method, a (pseudo) Newton method, a stochastic gradient method, or an Adam method as the second optimization method.

6. The model learning device according to claim 1, wherein the operations comprise:
updating the parameter using a third objective function obtained by regarding a value calculated on the basis of the hyperparameter as a pseudo output value corresponding to an input value to approximate the second objective function, and
estimating the optimization parameter that minimizes the third objective function.

7. A model learning method executed by an information processing device, the model learning method comprising:
acquiring learning data including grouped uncoupled data acquired from a plurality of groups to be investigated and grouped size comparison data;
executing processing of updating a hyperparameter using a first optimization method on the acquired grouped uncoupled data and estimating an optimization hyperparameter that minimizes a first objective function;
executing processing of updating a parameter using a second optimization method on the basis of the acquired grouped uncoupled data, the grouped size comparison data, and the estimated optimization hyperparameter, and estimating an optimization parameter that minimizes a second objective function; and
outputting the estimated optimization parameter.

8. A non-transitory computer readable medium storing one or more instructions for causing a processor included in a model learning device to execute:
acquiring learning data including grouped uncoupled data acquired from a plurality of groups to be investigated and grouped size comparison data;
executing processing of updating a hyperparameter using a first optimization method on the acquired grouped uncoupled data and estimating an optimization hyperparameter that minimizes a first objective function;
executing processing of updating a parameter using a second optimization method on the basis of the acquired grouped uncoupled data, the grouped size comparison data, and the estimated optimization hyperparameter, and estimating an optimization parameter that minimizes a second objective function; and
outputting the estimated optimization parameter.
